(19) United States
(12) Patent Application Publication
(10) Pub. No.: US 2010/0245170 A1
(43) Pub. Date: Sep. 30, 2010

(54) GNSS RECEIVER

(75) Inventor: Joel Brenner, Arzo (CH)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/744,023

(22) PCT Filed: Dec. 22, 2008
(86) PCT No.: PCT/EP08/68203

§ 371 Date: May 20, 2010

(30) Foreign Application Priority Data
Dec. 21, 2007 (EP) 07124014.7

(51) Int. Cl. G01S 19/42

(52) U.S. Cl. 342/357.25

(57) ABSTRACT

A GNSS receiver interfaceable to a host, in which the search functions in the acquisition phase are carried out by the host's resources. The receiver provides correlation samples to the host system by a dedicated high-speed interface, preferably a DMA interface.

### FIELD OF THE INVENTION

The present invention concerns a satellite radiolocalization receiver and in particular, but not exclusively, a radiolocalization receiver adapted to receive and process radiolocalization signals generated by a constellation of geo-localization satellite, like for example the satellites of the GPS, GLONASS or Galileo System or other global navigation satellite systems (GNSS). The present invention also concerns a signal processor unit adapted for treating demodulated radiolocalization signals provided by a suitable RF interface, and which can be embedded in a dedicated GNSS apparatus or in another host system, like for example a general-purpose computer, PDA or cell phone.

### DESCRIPTION OF RELATED ART

The Global Navigation Satellite Systems (GNSS) generically include the General Positioning System (GPS), operated by the United States, the Global Orbiting Navigation Satellite System (GLONASS) operated by the Russian Federation and the projected Galileo positioning system, to be built by the European Union.

The following description and examples will often refer, for the sake of simplicity, to a GPS receiver only. It will be understood, however, that he present invention is not necessarily restricted to such a receiver, but includes also all GNSS sources, and can be extended to other future radiolocalization systems to which the invention is applicable.

GNSS radio signals are located in the UHF portion of the radio spectrum, most often above 1 GHz, have power level, at ground, of the order of −120 dBm or less and are generally direct-sequence spread-spectrum signals modulated by pseudo-random code binary sequences, which are used in the receiver for positioning and navigation. The signal structure of GPS signals is described, for example, in international patent application WO05003807, in the name of the applicant, which is hereby incorporated by reference.

Satellite radiolocalization systems, such as GPS (Global Positioning System), GLONASS or Galileo rely on the reception of radio signals broadcast from a number of orbiting satellites and use the information contained in these signals to determine the distances, or ranges, from the receiver to each of the received satellites. The orbits of the satellites being known, absolute time and the location of the GPS receiver can then be determined geometrically.

Current state of the art High Sensitivity GNSS receivers can be categorized in two main types:
Autonomous or “stand alone” receivers
Hosted receivers

In the first type of receivers everything is computed in the GNSS receiver itself and only the Position Velocity Time PVT solution or maybe some other parameters of interest are communicated to the outside world.

In the second type of receivers, instead, the PVT solution is computed on a so called Host CPU. The GNSS receiver itself outputs the Satellite Carrier frequency/phase and the Code Phase measurements which are then used by the host system to compute the PVT solution.

In a hosted receiver approach the cost of the GNSS receiver is significantly reduced since the resources needed to produce a PVT solution have been omitted (memory, CPU performance, . . . ). In this configuration the GNSS receiver is responsible just for search, acquire and track GNSS satellite signals.

A typical high sensitivity hosted GNSS receiver may present the structure shown in FIG. 1 and comprise the following sub blocks:
A CPU 80 needed to control and interact with the different sub blocks
A GNSS RF Front-End 70 which has to down convert the signal from the GNSS antennas into a manageable intermediate frequency and usually performs the ND conversion
An massive parallel acquisition engine 100 which could be also built from several smaller sub-blocks
A tracking unit 200 needed to track/follow the Satellite signals and produce the measurements needed for the PVT solution.

One of the most area consuming blocks in the receiver of FIG. 1 is the acquisition engine 100. The tracking unit 200 also needs to have memory banks to store the correlation data of all the tracked satellites, and contributes significantly to the area of the receiver.

This becomes even more relevant considering that this unit is the less used during the functioning of the receiver this unit is the less used. In fact the acquisition unit 100 is active only during the initial satellite acquisition and, once all satellites have been acquired or the code phase/frequency uncertainty of the satellite to search has significantly shrunk, the receiver will turn it off and start on the tracking unit 200 instead. This inefficiency in silicon area use reflects negatively on the final device cost and size.

There is therefore a need for a GNSS receiver that is free from the shortcoming of the known devices illustrated above and, in particular, that uses silicon area more effectively.

Furthermore, it is a goal of the present invention to reduce the size of the acquisition engine in a GNSS receiver.

### BRIEF SUMMARY OF THE INVENTION

According to the invention the above technical problem is solved by the GNSS receiver that is the object of the appended claims.

### BRIEF DESCRIPTION OF THE DRAWINGS

The invention will be better understood with the aid of the description of an embodiment given by way of example and illustrated by the figures, in which:

FIG. 1 shows schematically the overall architecture of a hosted GNSS processor of known type.

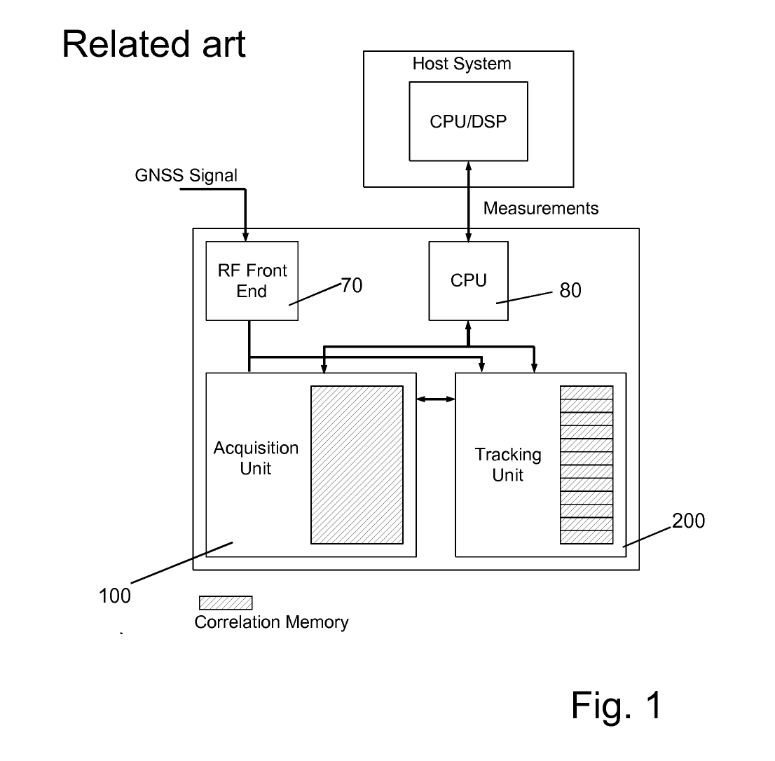

FIG. 2 illustrates schematically a processing line of a known GNSS correlator.

FIG. 3 shows schematically a hosted GNSS processor with a hosted acquisition engine according to one aspect of the present invention.

FIG. 4 shows schematically a hosted GNSS processor with a hosted acquisition engine according to another aspect of the present invention.

FIG. 5 shows schematically a hosted GNSS processor with a hosted tracking unit according to another aspect of the present invention.

### DETAILED DESCRIPTION

In the following specification, the terms “receiver”, “GNSS receiver” and “GPS receiver” can designate a complete self-contained receiver device, but also a module, included in a complex entity, for example a GPS or GNSS module in a cellular phone, a car alarm, a PDA (Portable Digital Assistant) and so forth. The terms above may also indicate a pluggable module, which may be connected with a hosting device by means of an appropriate bus, for example a GPS or GNSS PC-card, or a software code, containing executable code and/or circuit description instructions to implement a GPS or GNSS receiver function in an ASIC or in a set of integrated circuits. The term “GPS” should not be construed narrowly as indicating the NAVSTAR GPS system only, but rather as encompassing all similar satellite navigation systems including, among others, Galileo, GLONASS, Beidou/COMPASS, IRNSS, QZSS and so on.

The terms “receiver”, “GNSS receiver” and “GPS receiver” should also be understood, in the context of the present specification, as including one of more integrated circuits, arranged to realize a complete GPS or GNSS receiver or a complete GPS or GNSS module, as defined above.

In order to achieve cutting-edge expected performances, the acquisition engine 100 is built with one or more massive parallel correlators which are typically able to correlate and accumulate in parallel all or a subset of the PRN code phases over different frequencies.

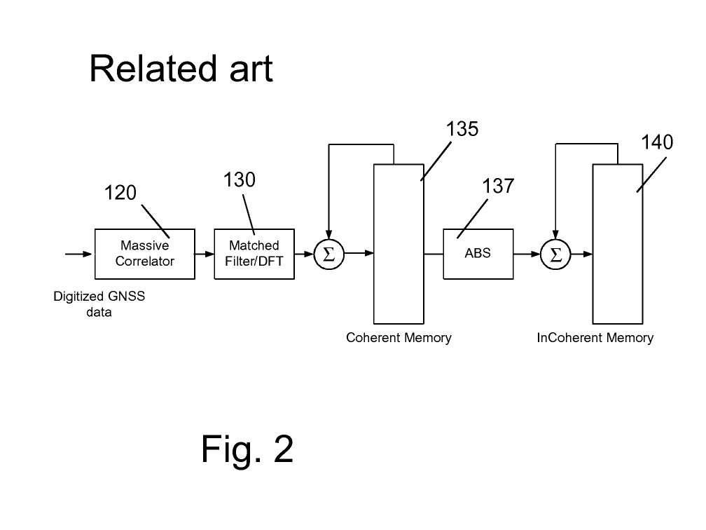

To achieve the required sensitivity the acquisition engine 100 first correlates the digitized input samples with the locally reproduced PRN code. FIG. 2 shows a conceptualized processing schematics of a GNSS acquisition engine that is implemented, with the appropriate variations, in a host of “time domain” massive parallel correlation/acquisition engines.

The complex samples produced by the massive correlator 120 are then coherently processed/by means of a bank of matched filters/DFTs or an FFT 130 and integrated for to a specified coherent period (typically 4, 8, 16 or 20 mS for a GPS satellite) into the coherent memory 135, This generates correlation value images at different frequencies for each candidate signal. At the end of such coherent accumulation phase the results of the DFT/FFT or matched filters are squared or, more in general, their complex magnitude is computed (absolute value block 137), and added in an ordered manner to the content of a incoherent accumulation memory 140. The whole process is continued until the required sensitivity is reached. At this point the incoherent memory will be processed in order to detect the presence of a correlation peak.

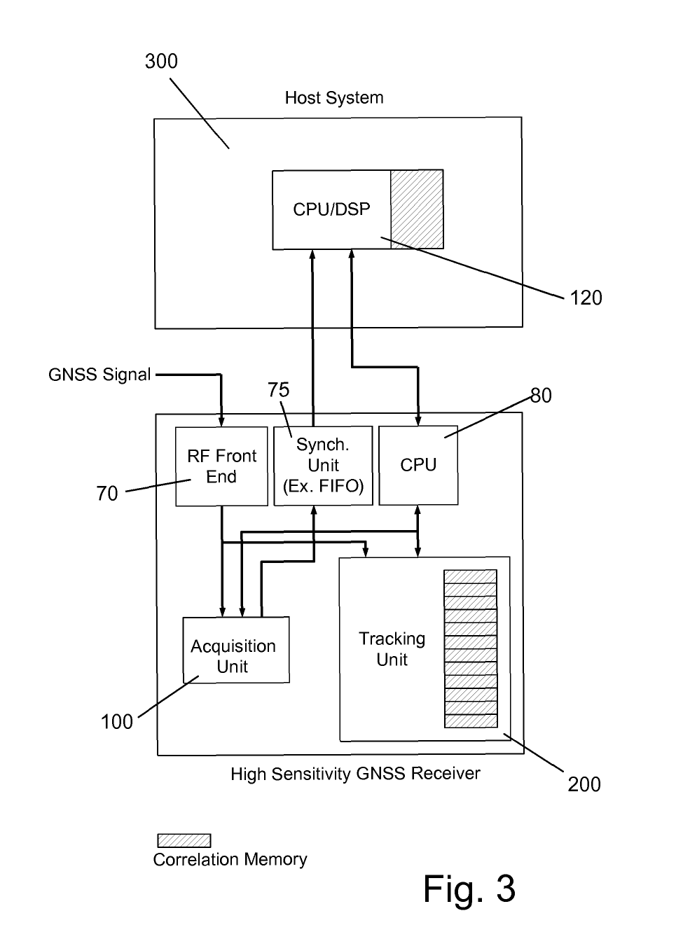

As shown in FIG. 3, one aspect of the present invention relates to a GNSS receiver in which almost all of the correlation/accumulation memory in the acquisition engine 100 has been removed. In this case the acquisition engine 100 only performs the massive correlation over the whole or sub-set of the PRN code phases without any further accumulation filtering or frequency processing.

The complex result of the pure correlation instead is transferred into the host system 300 by means of a dedicated high speed/bandwidth unidirectional interface 75. The host's CPU/DSP 120 takes care of doing the matched filter/DFT/FFT processing and uses its own memory for the accumulations. The CPU 120 of the host 300 is also responsible for the incoherent memory processing once the whole accumulation has been completed or runtime during the accumulation phase itself. The host system 300 could be any kind of mobile terminal, for example a personal computer, a laptop, a PDA a mobile communication device or a mobile phone.

The interface 75 can have various structures, all included in the scope of the invention. According to a preferred embodiment, it is organized as a FIFO, in which are stored instantaneous or recent correlation values obtained by the acquisition unit 100. The data are then transferred to the memory of the host 300 in the same order as they are received. According to the need or the architectural choices, the correlation data may be individually tagged with the relevant information needed for their processing (for example Doppler shift, code shift, PRN id, time of acquisition and so on), or organized in blocks according to these information.

The host system executes the necessary computing tasks that are traditionally carried out by dedicated hardware in the acquisition unit 100 including, for example, DFT/FFD matched filtering, coherent integration absolute value computation, incoherent integration. Additionally the host system might be programmed, if appropriate, to execute also some tasks that should be done by the CPU 80 of the GNSS receiver, like, for example, search for taps characterized by a Doppler shift and a code shift showing a significant correlation value.

The incoherent memory analysis will result into one or more acquisition commands sent back to the GNSS receiver, preferably to the CPU 80 of the GNSS receiver, which will then start one or more search processes directly on the tracking channels or reconfigure the acquisition unit or a sub-block of it accordingly.

In order to minimize the host system transfer overhead it is preferable to use a DMA engine which transfers directly the correlation samples from the GNSS receiver into the host memory.

The advantage of the above presented approach consist in the fact that a relevant part of the acquisition resources aren't any more invariably allocated into the GNSS receiver but are dynamically allocated in the host system 300 only when and if they are needed.

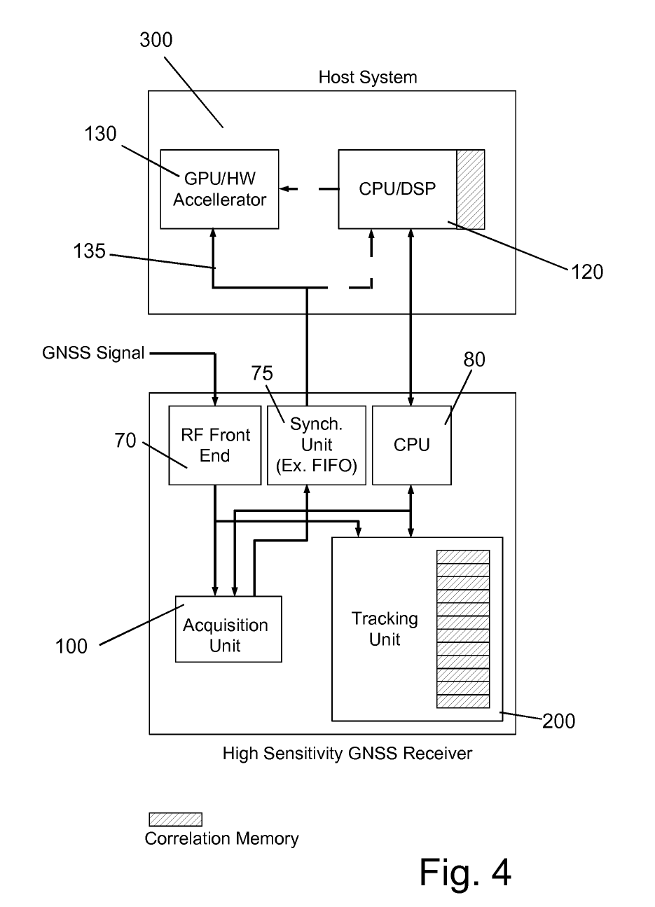

FIG. 4 presents another embodiment of the hosted acquisition engine of the invention. In the previous embodiment of FIG. 3, the CPU or DSP 120 of the host 300 is responsible for executing all the computation requested by the acquisition unit 100, which may or may not be possible depending from the available resources and system load. In this embodiment instead, the host's CPU/DSP 120 does not processes directly the correlation samples but makes use of one or more HW acceleration units 130. Those units may already be present in the host system and used for other purposes or have been added exclusively to accommodate the operations needed by the hosted acquisition engine of the invention.

As an example a Graphic Processing Unit 130 could be reconfigured in order to perform all the needed operations in a very efficient way and minimizing the data transfer overhead. In this case the correlation data coming from the GNSS receiver could be transferred directly into the HW accelerator by means of a DMA mechanism (arrow 135), and the CPU/DSP has to be involved only at the very end of the correlation/acquisition phase in order to communicate the search results to the GNSS receiver (dashed arrows). In another variant, the HW acceleration unit may consist in a sound processing unit.

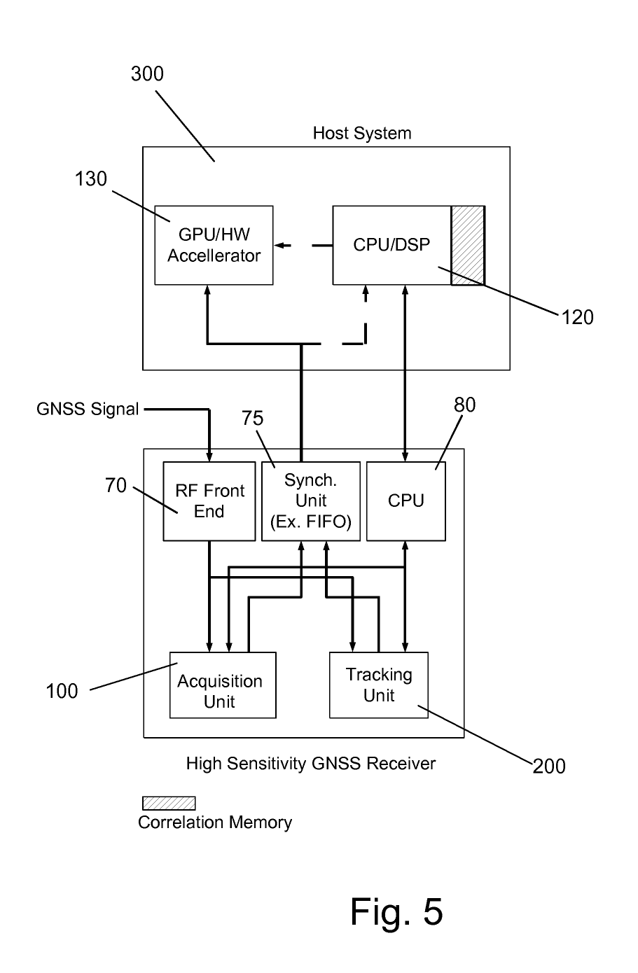

FIG. 5 presents a further embodiment of the invention in which the tracking unit 200 is also delegating the part of the tracking process to the host system 300, in analogous manner to the acquisition unit 100. In this case the tracking unit 200 transfers directly the instantaneous or short-term correlation data into the memory of the host system 300 by the interface block 75. As above, the host system 300 preferably includes a HW acceleration units 130, for example a Graphic Processing Unit (GPU) or a sound processing unit.

1. A GNSS receiver interfaceable with a host (300) comprising an acquisition engine (100) having a correlation unit providing a plurality of correlation samples and a data transfer interface (75) operatively arranged to transfer the correlation samples to the host system (300).

2. The GNSS receiver of the preceding claim, wherein the data transfer interface (75) includes a dedicated high speed unidirectional DMA system to transfer the correlation samples from the GNSS receiver into the memory of the host (300).

3. The GNSS system of any of the preceding claims, further comprising a tracking unit (200), operatively arranged to track a number of GNSS signals by their values of Doppler shift and code shift, and to provide ranging measurements to the host system.

4. The GNSS receiver of claim 3, wherein the tracking unit (200) is operatively arranged to transfer correlation data to the host system (300) by the data transfer interface.

5. The GNSS receiver of any of the previous claims, wherein the data transfer interface transfers the data to the host in the same order in which it has received them.

6. The GNSS receiver of any of the preceding claims, in combination with an host system (300) interfaced thereto, wherein the host system is operatively arranged to perform DFT and/or FFT operations on the correlation samples of the GNSS receiver to obtain integration values for a plurality of correlation taps corresponding to a plurality of Doppler shift and code shift values.

7. The GNSS receiver of the preceding claim, in which the host system (300) further comprises a hardware acceleration unit (130).

8. The GNSS receiver of the preceding claim, in which the hardware acceleration unit (130) consists in a Graphic Processing Unit.

9. The GNSS receiver of the any of the claims 6-7, wherein the host system is operatively arranged to time-integrate said correlation taps.

10. The GNSS receiver of the preceding claim, wherein the host system is operatively arranged to compute the absolute value or the square of the time-integrated correlation taps, and or to integrate said absolute values or square values providing a incoherent accumulated value.

11. The GNSS receiver of any of the claims 6-10, the host system being operatively arranged to search for correlation peaks corresponding to a GNSS signal having a Doppler shift and a code shift.

12. The GNSS receiver of any of the claims 6-11, the host system being a personal computer, a laptop, a PDA a mobile communication device or a mobile phone.
